(19) United States
(12) Patent Application Publication
(10) Pub. No.: US 2007/0052622 A1
(43) Pub. Date: Mar. 8, 2007

(54) Plasma display apparatus

(75) Inventor: Jeong Pil Choi, Suwon-si (KR)

Correspondence Address: FLESHNER & KIM, LLP, P.O. BOX 221200, CHANTILLY, VA, 20153, US

(73) Assignee: LG Electronics Inc.

(21) Appl. No.: 11/514,908

(22) Filed: Sep. 5, 2006

(30) Foreign Application Priority Data
Sep. 6, 2005 (KR) 10-2005-0082936

(51) Int. Cl. G09G 3/28

(52) U.S. Cl. 345/63

(57) ABSTRACT

A plasma display apparatus is disclosed. The plasma display apparatus includes a timing controller. The timing controller controls a duration of a rising period of at least one sustain pulse supplied to electrodes during a sustain period of at least one subfield of a plurality of subfields to be different from a duration of a rising period of sustain pulses supplied to the electrodes during sustain periods of the remaining subfields. Further, the timing controller controls a duration of a rising period of at least one of a plurality of sustain pulses supplied to the electrodes during a sustain period of at least one subfield of the plurality of subfields to be different from a duration of a rising period of the remaining sustain pulses supplied to the electrodes.

This Nonprovisional application claims priority under 35 U.S.C. § 119(a) on Patent Application No. 10-2005-0082936 filed in Korea on Sep. 6, 2005 the entire contents of which are hereby incorporated by reference.

### BACKGROUND

1. Field

This document relates to a plasma display apparatus.

2. Description of the Background Art

A plasma display apparatus comprises a plasma display panel including a plurality of electrodes and a driver for driving the plurality of electrodes of the plasma display panel.

The plasma display panel is formed by coalescing a front panel including a front substrate and a rear panel including a rear substrate.

A discharge cell is formed between the front substrate and the rear substrate.

The driver supplies a predetermined driving voltage to the discharge cell of the plasma display panel in a plurality of subfields of a frame, and thus generating a reset discharge, an address discharge and a sustain discharge inside the discharge cell.

When generating the discharge inside the discharge cell by the supplying of the predetermined driving voltage, a discharge gas filled in the discharge cell generates high frequency light such as vacuum ultraviolet rays.

The high frequency light causes a phosphor formed inside the discharge cell to emit light, and a phosphor layer then generates visible light, thereby displaying an image.

Since the plasma display apparatus can be manufactured to be thin and light, it has attracted attention as a next generation display device.

A related art plasma display apparatus achieves gray level of an image during each sustain period in all subfields of a frame using one or more pairs of sustain pulses.

Accordingly, the related art plasma display apparatus can achieve gray level of a natural number of such as 1, 2, 3.

### SUMMARY

Embodiments provide a plasma display apparatus capable of representing various gray levels of an image.

In one aspect, a plasma display apparatus comprises a plasma display panel comprising a plurality of electrodes, a scan driver for supplying a plurality of sustain pulses to the plurality of electrodes during a sustain period of each of a plurality of subfields, and a timing controller for controlling a duration of a rising period of at least one sustain pulse supplied to the electrodes during a sustain period of at least one subfield of the plurality of subfields to be different from a duration of a rising period of sustain pulses supplied to the electrodes during sustain periods of the remaining subfields, and for controlling a duration of a rising period of at least one of a plurality of sustain pulses supplied to the electrodes during a sustain period of at least one subfield of the plurality of subfields to be different from a duration of a rising period of the remaining sustain pulses supplied to the electrodes.

In another aspect, a plasma display apparatus comprises a plasma display panel comprising a plurality of electrodes, a scan driver for supplying the same number of sustain pulses to the plurality of electrodes during a sustain period of each of a plurality of subfields, and a timing controller for controlling a duration of a rising period of at least one sustain pulse supplied to the electrodes during a sustain period of at least one subfield of the plurality of subfields to be different from a duration of a rising period of sustain pulses supplied to the electrodes during sustain periods of the remaining subfields.

Implementations may include one or more of the following features. For example, the plurality of sustain pulses are supplied to the electrodes during a sustain period of one subfield to increase, or reduce, or increase and then reduce luminance of a gray level of the subfield as a sustain period in one subfield elapses.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

### BRIEF DESCRIPTION OF THE DRAWINGS

The accompany drawings, which are included to provide a further understanding of the invention and are incorporated on and constitute a part of this specification illustrate embodiments of the invention and together with the description serve to explain the principles of the invention.

FIG. 1 is a block diagram of a plasma display apparatus;

FIG. 2 illustrates the structure of a plasma display panel of the plasma display apparatus;

FIG. 3 illustrates a method of driving the plasma display panel;

FIG. 4 illustrates a relationship between an ER period of a sustain pulse supplied to the plasma display panel and luminance;

FIG. 5 illustrates a method for controlling an ER period of the sustain pulse; and

FIGS. 6a to 6c illustrate different implementations of a method for changing an ER period of a sustain pulse supplied to an electrode of the plasma display panel of the plasma display apparatus in each of subfields.

### DETAILED DESCRIPTION OF PREFERRED EMBODIMENTS

Preferred embodiments of the present invention will be described in a more detailed manner with reference to the drawings.

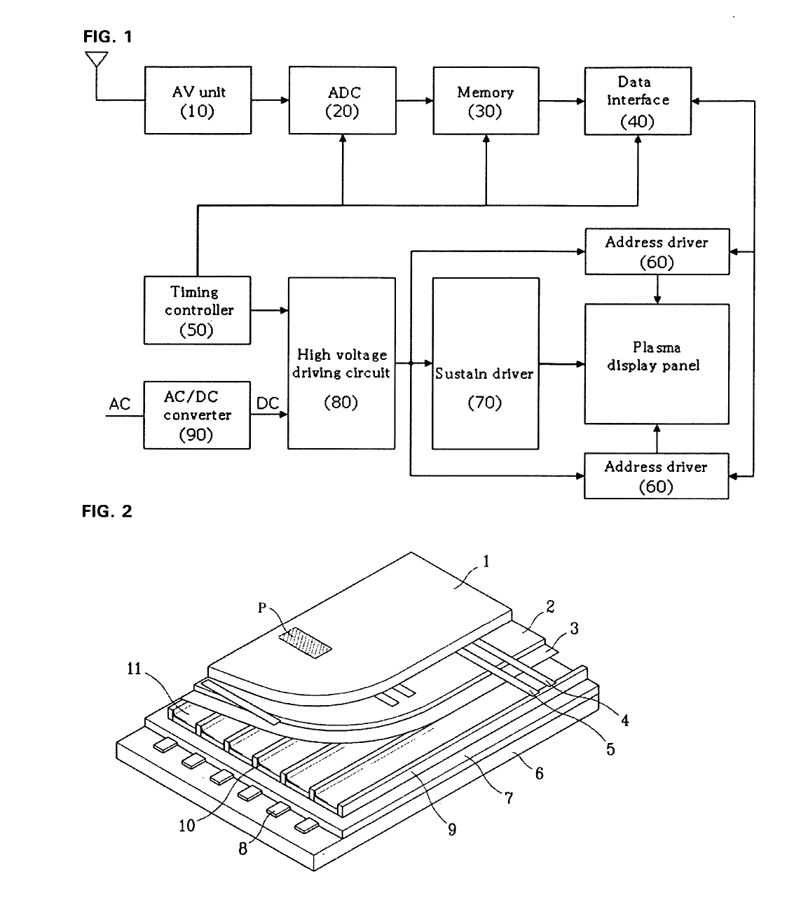

FIG. 1 is a block diagram of a plasma display apparatus.

Referring to FIG. 1, the plasma display apparatus comprises a plasma display panel on which an image is displayed and several drivers for driving the plasma display panel.

An audio-visual (AV) unit 10 receives a composite signal, divides the composite signal into analog R, G and B signals and a vertical/horizontal synchronization signal, obtains an average picture level (APL) corresponding to an average value of a luminance signal from the analog R, G and B signals, and supplies the obtained APL to an analog-digital converter (ADC) 20. The APL is used to improve luminance of a PDP TV set.

The ADC 20 amplifies the inputted analog R, G and B signals and an APL signal at a proper level suitable to quantization, outputs a clock synchronized with an input synchronization signal, performs one-to-one mapping of outputted R, G and B data depending on APL data, and supplies the mapped data to a memory 30.

The memory 30 stores image data, which is reconstituted in each of a plurality of subfields for representing various gray levels of an image, and supplies the image data corresponding to each of the subfields to a data interface 40.

The data interface 40 temporarily stores R, G and B data supplied from the memory 30, converts the R, G and B data into a type of data required in an address driver 60, and provides the converted R, G and B data.

The timing controller 50 controls a signal processing of the memory 30 and the data interface 40, and supplies a reference signal and a main clock for to the data interface 40 to produce a signal for controlling input and output of digital image data of a quantity of one line shifted from the memory 30.

In other words, the timing controller 50 produces a control pulse for controlling switch timing required in the address driver 60 and a scan driver 70. In particular, the timing controller 50 produces the control pulse for controlling sustain-up switch timing such that an ER period of the control pulses during a sustain period is different from.

A high voltage driving circuit 80 combines various control pulses output to the timing controller 50 and a DC voltage supplied from an AC/DC converter 90, and supplies a driving pulse to the address driver 60 and the scan driver 70. Further, the high voltage driving circuit 80 raises data stream which the data interface 40 supplies to the address driver 60 at a proper voltage level such that a selective entry to the plasma display panel is possible.

The AC/DC converter 90 receives an AC power source to an input, produces a high voltage required to combine driving pulses to be supplied to each electrode, and the supplies the high voltage.

The scan driver 70 comprises an energy recovery circuit (not illustrated) for reducing a driving power required in a discharge. The energy recovery circuit recovers a charge voltage to a scan electrode, a charge voltage to a sustain electrode and a charge voltage to an address electrode, and reuses the recovered voltage as a driving voltage in a next discharge.

For this, the energy recovery circuit comprises an inductor (not illustrated) and a source capacitor (not illustrated). The inductor and a panel capacitor form a LC resonance circuit. The source capacitor stores energy used in a charging operation and a discharging operation of the panel capacitor. The panel capacitor equivalently indicates a capacitance formed between the scan electrode and the sustain electrode.

As the timing controller 50 operates a sustain-up switch when LC resonance occurs in the energy recovery circuit, a sustain pulse rising to a positive sustain voltage is generated. A rising period of a sustain pulse (hereinafter, referred to as an ER period) is defined as a duration of time ranging from a start time point of the LC resonance to a time point before operating the sustain-up switch.

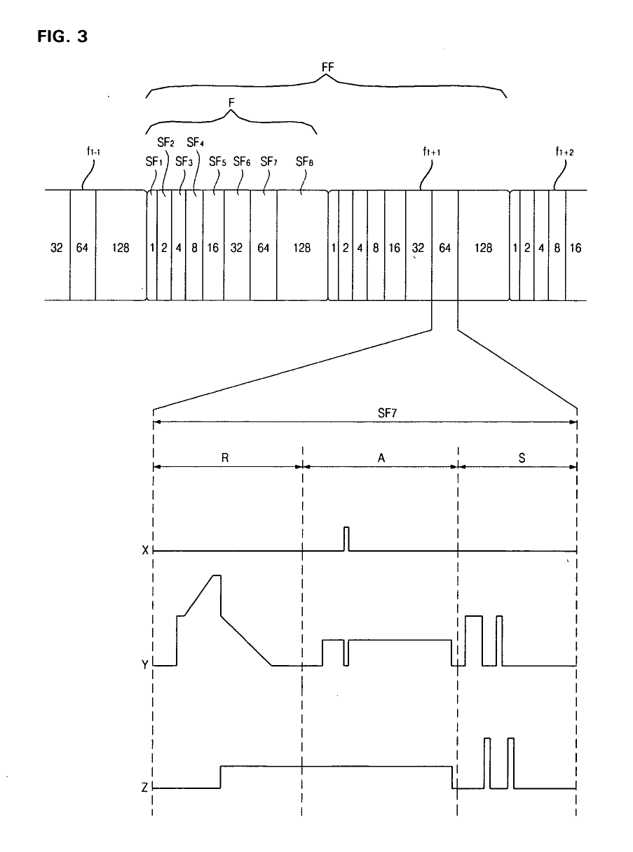

The plasma display panel, as illustrated in FIG. 2, comprises a first substrate 1 and a second substrate 6 which are coalesced in parallel to each other at a given distance therebetween.

On the first substrate 1, a scan electrode 4 and a sustain electrode 5 being covering with a dielectric layer 2 and a protective layer 3 are formed in pairs in parallel to each other.

The scan electrode 4 and the sustain electrode 5 each may comprise a transparent electrode and a metal electrode. The protective layer 3 is formed on the surface of the dielectric layer 2.

On the second substrate 6, a plurality of address electrodes 8 being covering with an insulating layer 7 are formed. A barrier rib 9 is formed on the insulating layer 7 between the address electrodes 8. A phosphor layer 10 is formed on the surface of the insulating layer 7 and the barrier rib 9.

The first substrate 1 and the second substrate 6 are disposed to oppose to each other such that a discharge space 11 is formed between the scan and sustain electrodes 4 and 5 and the address electrode 8. The discharge space 11 forms one discharge cell P.

The discharge space 11 is filled with a discharge gas. The R, G and B phosphor layers 10 are excited by ultraviolet rays when generating a discharge, thereby emitting light.

The discharge cell is an emission area of one color and form a sub-pixel. Three R, G and B sub-pixels form one pixel P.

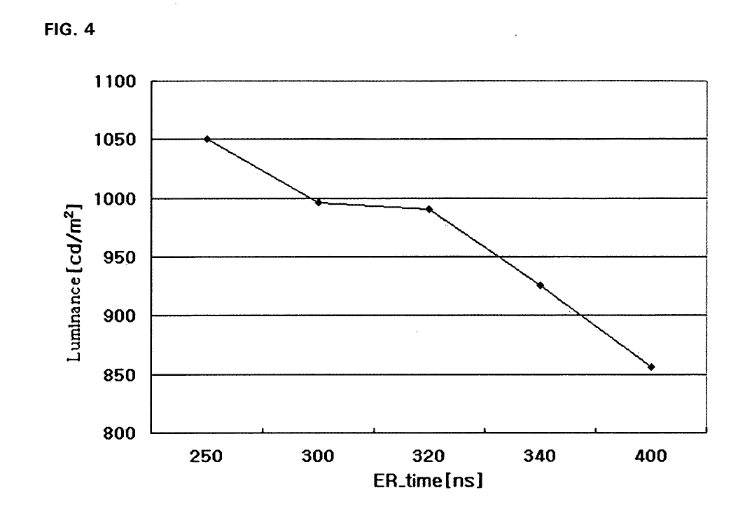

A method of driving the plasma display panel with the above-described structure is illustrated in FIG. 3.

As illustrated in FIG. 3, in the method of driving the plasma display panel, one frame for displaying an image includes a plurality of subfields, and each of the plurality of subfields includes a reset period (R), an address period (A) and a sustain period (S).

FIG. 3 illustrates a driving pulse supplied to each of the electrodes in a seventh subfield. In FIG. 3, X indicates the address electrodes, Y the scan electrode, and Z the sustain electrode.

During the reset period (R), wall charges accumulated by performing the previous sustain discharge are erased, and a state of all the discharge cells is initialized. During the address period (A), a discharge cell to be discharged is selected.

During the sustain period (S), a discharge for displaying the image occurs in the selected discharge cell. Further, a sustain pulse is alternately supplied to the scan electrode Y and the sustain electrode Z such that a sustain discharge occurs, thereby displaying the image.

For example, if an image with 256-level gray scale is to be displayed, one sustain pulse, 2 sustain pulses, 4 sustain pulses, 8 sustain pulses, 16 sustain pulses, 32 sustain pulses, 64 sustain pulses and 128 sustain pulses are assigned in eight subfields SF1 to SF8, respectively. The number of sustain pulses is proportional to luminance in a unit subfield.

Accordingly, when one sustain pulse is assigned in the first subfield SF1 and unit luminance in the first subfield SF1 is equal to 1 cd/m2, gray level having luminance of 0-255 cd/m2 can be represented by combining the eight subfields SF1 to SF8.

As described above, the plasma display apparatus achieves gray level of the image by controlling the number of sustain pulses supplied to the electrodes of the plasma display panel on which the image is displayed. To achieve more minutely gray level, the ER period of the sustain pulse may be controlled.

The above-described timing controller of the plasma display apparatus can control the duration of the ER period of the sustain pulse supplied to the scan electrode and the sustain electrode during a sustain period of at least one subfield of the plurality of subfields to be different from the duration of the ER period of the sustain pulse supplied to the scan electrode and the sustain electrode during sustain periods of the remaining subfields, when driving the plasma display panel.

Further, the timing controller controls the duration of the ER period of a sustain pulse supplied to the scan electrode and the sustain electrode during a sustain period of at least one subfield of the plurality of subfields to be different from the duration of the ER period of the remaining sustain pulses supplied to the scan electrode and the sustain electrode.

In such a case, the sustain pulse supplied during the sustain period of at least one subfield of the plurality of subfields may be equal to at least one sustain pulse of the plurality of sustain pulses.

More specifically, when one frame includes eight subfields, as illustrated in FIG. 3, the timing controller controls a duration of an ER period of any sustain pulse of sustain pulses supplied to the scan electrode or the sustain electrode during a sustain period of the seventh subfield of the eight subfields to be different from the duration of the ER period of the sustain pulses supplied to the scan electrode or the sustain electrode during the sustain periods of the remaining seven subfields, by controlling turn-on time using a sustain voltage supply switch of an energy recovery circuit of the scan driver.

Further, the timing controller controls the duration of the ER period of at least one sustain pulse of the plurality of sustain pulses supplied to the scan electrode or the sustain electrode during the sustain period of the seventh subfield to be different from the duration of the ER period of the remaining sustain pulses supplied to the scan electrode or the sustain electrode during the sustain period of the same seventh subfield.

Since the sustain voltage supply switch of the energy recovery circuit is well known to those skilled in the art, a description thereof is omitted.

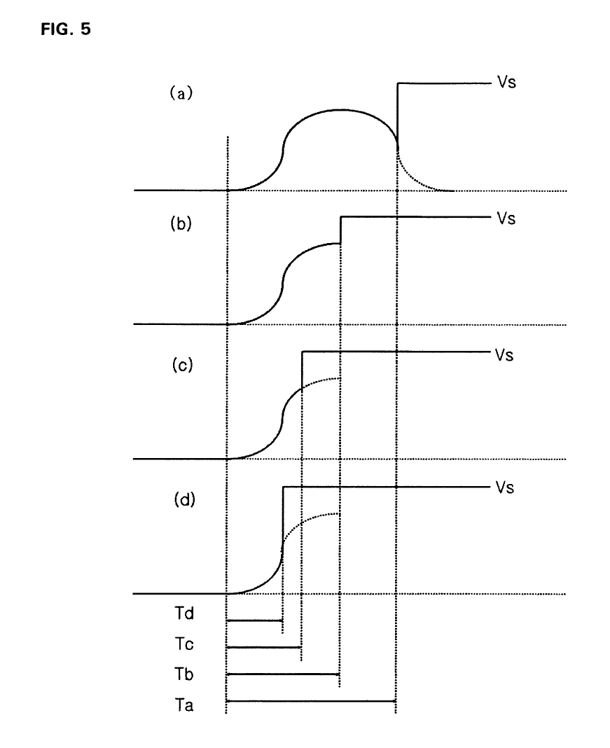

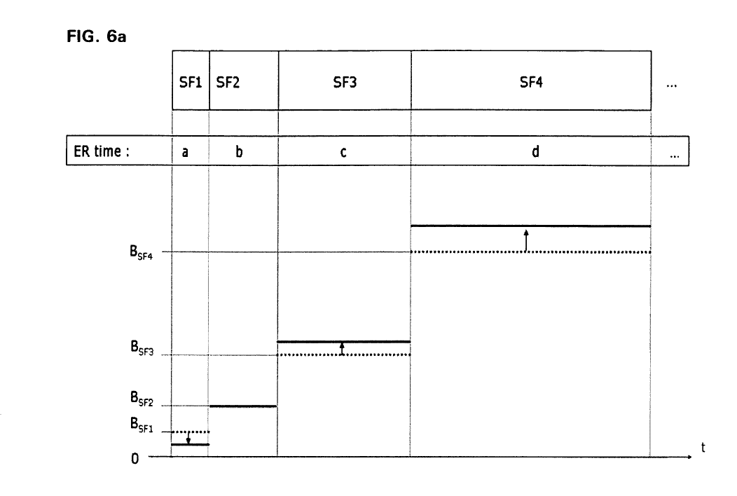

FIG. 4 illustrates a relationship between an ER period of a sustain pulse supplied to the plasma display panel and luminance. FIG. 5 illustrates a method for controlling an ER period of the sustain pulse.

Referring to FIG. 4, as the ER period of the sustain pulse lengthens, the luminance is reduced due to the generation of the sustain discharge is. Accordingly, the plasma display apparatus, as illustrated in FIG. 5, controls the duration of the ER period of the sustain pulse by controlling the turn-on time of the sustain voltage supply switch of the energy recovery circuit.

(a) of FIG. 5 is a graph of an operation of a sustain-up switch for supplying a sustain pulse of a high voltage, after a reaching time point of a highest voltage due to the LC resonance. (b) of FIG. 5 is a graph of an operation of the sustain-up switch at the reaching time point of the highest voltage due to the LC resonance. (c) of FIG. 5 is a graph of an operation of the sustain-up switch before the reaching time point of the highest voltage due to the LC resonance. (d) of FIG. 5 is a graph of an operation of the sustain-up switch directly after a start time point of the LC resonance.

In (a) to (d) of FIG. 5, Ta, Th, Tc and Td each indicate an ER period. As illustrated in FIG. 5, the duration of the ER period is inversely proportional to the luminance. For example, a duration of the ER period in (d) of FIG. 5 is shortest among (a) to (d) of FIG. 5, and thus the luminance in (d) of FIG. 5 is highest among (a) to (d) of FIG. 5.

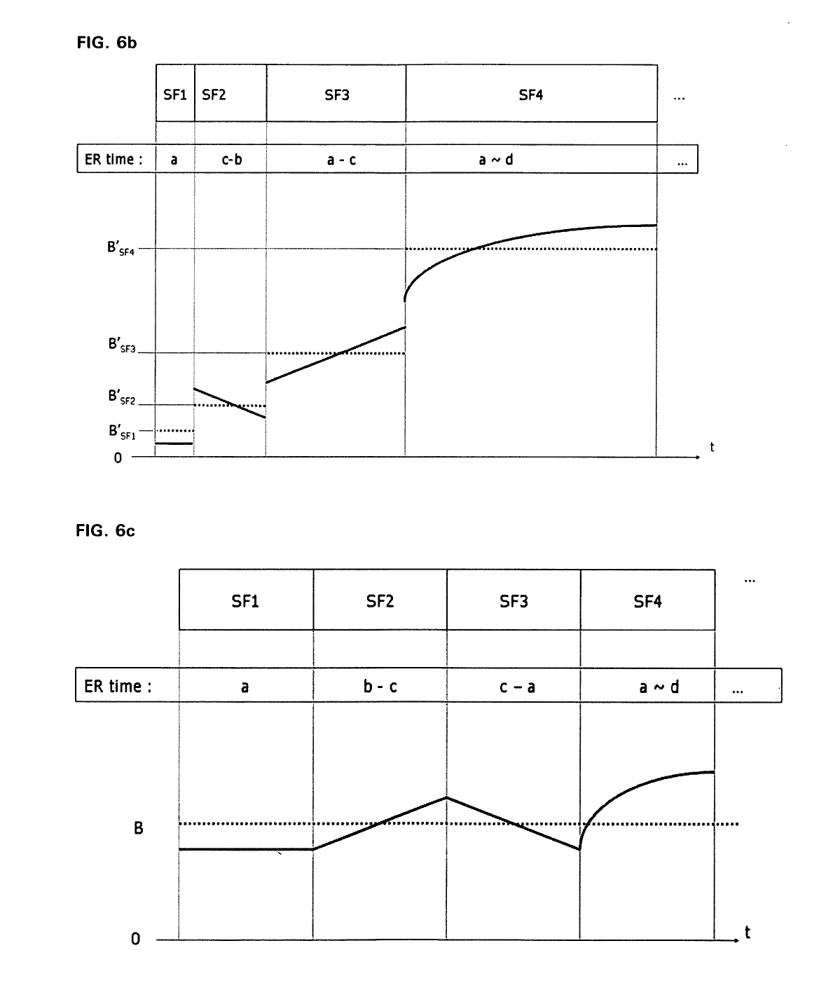

FIGS. 6a to 6c illustrate different implementations of a method for changing an ER period of a sustain pulse supplied to an electrode of the plasma display panel of the plasma display apparatus in each of subfields.

In FIGS. 6a to 6c, an X axis indicates a time axis, and a Y axis indicates a luminance axis. Further, the dotted line in a graph illustrated in FIGS. 6a to 6c indicates fixed luminance in each of a plurality of subfields, because a plurality of sustain pulses supplied to a scan electrode or a sustain electrode in a related art plasma display apparatus have the same ER period. The solid line in a graph indicates luminance due to a change in the duration of the ER period of the sustain pulse supplied to the electrodes of the plasma display panel.

As illustrated in FIG. 6a, the ER period in the first subfield SF1, as illustrated in a reference character (a), is longer than the ER period in the related art such that luminance is lower than luminance of the related art. In the second subfield SF2, the duration of the ER period, as illustrated in a reference character (b), is equal to a duration of the ER period in the related art such that luminance is equal to luminance of the related art. In the third subfield SF3, the ER period, as illustrated in a reference character (c), is shorter than the ER period of the related art such that luminance is higher than luminance of the related art. In the fourth subfield SF4, the ER period, as illustrated in a reference character (d), is much shorter than the ER period of the related art such that luminance is much higher than luminance of the related art.

In other words, FIG. 6a illustrates one implementation of the method of driving the plasma display apparatus in which one frame including at least one subfield having different the ER period is configured.

Preferably, the ER period of a sustain pulse supplied to the scan electrode or the sustain electrode in a low gray level subfield of the plurality of subfields constituting one frame is longer than the ER period of sustain pulses supplied to the scan electrode or the sustain electrode in the remaining subfields except the low gray level subfield.

The low gray level subfield is the subfield with low luminance. The number of low gray level subfields is equal to one half the total number of subfields constituting one frame. Of course, the number of low gray level subfields can be controlled by adjusting a critical value of luminance of the subfields.

As illustrated in FIG. 6b, the ER period in the first subfield SF1, as illustrated in the reference character (a) of FIG. 6a, is longer than the ER period in the related art such that luminance is lower than luminance of the related art. In the second subfield SF2, the duration of the ER period, as illustrated in the reference character (b) of FIG. 6a, is equal to the duration of the ER period in the related art and then shortens as illustrated in the reference character (c) of FIG. 6a by operating the sustain-up switch at a certain time point such that luminance linearly decreases in the second subfield SF2.

In the third subfield SF3, the ER period is longer than the ER period in the related art and then changes as illustrated in the reference character (c) of FIG. 6a by operating the sustain-up switch at a certain time point such that luminance linearly increases in the third subfield SF3.

In the fourth subfield SF4, the ER period, as illustrated in the reference character (a) of FIG. 6a, is longer than the ER period in the related art such that luminance is lower than luminance of the related art. Then, the ER period sequentially shortens in order of the reference characters (b), (c) and (d) of FIG. 6a such that luminance gradually increases in the fourth subfield SF4.

In other words, in another implementations of the method driving the plasma display apparatus illustrated in FIG. 6b, the ER period of the plurality of sustain pulses supplied to the scan electrode or the sustain electrode during a sustain period of a subfield increases or decreases as a sustain period in one subfield elapses.

Further, although it is not illustrated in FIG. 6b, in another implementations of the method driving the plasma display apparatus, the ER period of the plurality of sustain pulses supplied to the scan electrode or the sustain electrode during sustain periods of subfields may increase or decrease as a sustain period in one subfield elapses.

In FIG. 6c, the number of sustain pulses supplied to the scan electrode or the number of sustain pulses supplied to the sustain electrode in a unit subfield is equal to the number of sustain pulses supplied to the scan electrode or the number of sustain pulses supplied to the sustain electrode in another unit subfield, and at the same time, the ER period of one or more sustain pulses supplied in each of the unit subfields changes.

In the first subfield SF1, the ER period, as illustrated in the reference character (a) of FIG. 6a, is longer than the ER period in the related art such that luminance is lower than luminance of the related art. In other words, there is no change in the ER period in the first subfield SF1. In the second subfield SF2, the ER period shortens from the reference character (b) to the reference character (c) of FIG. 6a such that the luminance increases linearly. In the third subfield SF3, the ER period lengthens from the reference character (c) to the reference character (a) of FIG. 6a such that the luminance decreases linearly.

In the fourth subfield SF4, the ER period, as illustrated in the reference character (a) of FIG. 6a, is longer than the ER period in the related art such that luminance is lower than luminance of the related art. Then, the ER period sequentially shortens in order of the reference characters (b), (c) and (d) of FIG. 6a such that luminance gradually increases in the fourth subfield SF4.

In other words, in still another implementations of the method driving the plasma display apparatus illustrated in FIG. 6c, when the same number of sustain pulses is supplied to the scan electrode or the sustain electrode in each of the subfields, the sustain pulses having the same duration of the ER period or the sustain pulses having different durations of the ER period are supplied in each of the subfields, thereby controlling the luminance.

In particular, in still another implementations of the method driving the plasma display apparatus illustrated in FIG. 6c, since the same gray level weight of each of the subfields is represented for one screen, flicker caused by combining the plurality of subfields having different gray level weights is improved.

In different implementations of the method of driving the plasma display apparatus illustrated in FIGS. 6a to 6c, it is preferable that a voltage of a sustain pulse or a duration of time of the maintaining of the sustain pulse supplied to the scan electrode or the sustain electrode is equal to a voltage of another sustain pulse or a duration of time of the maintaining of another sustain pulse during the sustain period of the subfield. However, a voltage of a sustain pulse or a duration of time of the maintaining of the sustain pulse may be different from a voltage of another sustain pulse or a duration of time of the maintaining of another sustain pulse.

In other words, a voltage of each of a plurality of sustain pulses or a duration of time when each of the plurality of sustain pulses is maintained at a constant voltage level is controlled to supply the plurality of sustain pulses, in which the luminance of an image increases or decreases or increases and decreases, to the scan electrode or the sustain electrode as a sustain period in one subfield elapses.

Accordingly, gray level of an image displayed on the plasma display panel when driving the plasma display apparatus is represented more minutely.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures. Moreover, unless the term “means” is explicitly recited in a limitation of the claims, such limitation is not intended to be interpreted under 35 USC 112(6).

What is claimed is:

1. A plasma display apparatus comprising:
a plasma display panel comprising a plurality of electrodes;
a scan driver for supplying a plurality of sustain pulses to the plurality of electrodes during a sustain period of each of a plurality of subfields; and
a timing controller for controlling a duration of a rising period of at least one sustain pulse supplied to the electrodes during a sustain period of at least one subfield of the plurality of subfields to be different from a duration of a rising period of sustain pulses supplied to the electrodes during sustain periods of the remaining subfields, and for controlling a duration of a rising period of at least one of a plurality of sustain pulses supplied to the electrodes during a sustain period of at least one subfield of the plurality of subfields to be different from a duration of a rising period of the remaining sustain pulses supplied to the electrodes.

2. The plasma display apparatus of claim 1, wherein a duration of the rising period of the plurality of sustain pulses increases as a sustain period in one subfield elapses.

3. The plasma display apparatus of claim 1, wherein a duration of the rising period of the plurality of sustain pulses decreases as a sustain period in one subfield elapses.

4. The plasma display apparatus of claim 1, wherein a duration of the rising period of the plurality of sustain pulses increases and then decreases as a sustain period in one subfield elapses.

5. The plasma display apparatus of claim 1, wherein a sustain voltage supply switch of the scan driver controls a duration of the rising period of the plurality of sustain pulses through the control of turn-on time of the switch.

6. The plasma display apparatus of claim 1, wherein the plurality of sustain pulses are supplied to the electrodes during a sustain period of one subfield to increase luminance of a gray level of the subfield as a sustain period in one subfield elapses.

7. The plasma display apparatus of claim 1, wherein the plurality of sustain pulses are supplied to the electrodes during a sustain period of one subfield to reduce luminance of a gray level of the subfield as a sustain period in one subfield elapses.

8. The plasma display apparatus of claim 1, wherein the plurality of sustain pulses are supplied to the electrodes during a sustain period of one subfield to increase and then reduce luminance of a gray level of the subfield as a sustain period in one subfield elapses.

9. The plasma display apparatus of claim 1, wherein the plurality of sustain pulses supplied to the electrodes during the sustain period of each of the plurality of subfields have a substantially constant voltage level.

10. The plasma display apparatus of claim 1, wherein a duration of time when one sustain pulse of the plurality of sustain pulses supplied to the electrodes is maintained at a constant voltage level during the sustain period of each of the plurality of subfields is equal to a duration of time when another sustain pulse of the plurality of sustain pulses is maintained at a constant voltage level.

11. The plasma display apparatus of claim 1, wherein a duration of a rising period of at least one sustain pulse supplied to the electrodes in a low gray-level subfield of the plurality of subfields is more than a duration of a rising period of the sustain pulses supplied to the electrodes in the remaining subfields except the low gray-level subfield.

12. The plasma display apparatus of claim 11, wherein the number of low gray-level subfields is one half the total number of subfields in one frame.

13. The plasma display apparatus of claim 1, wherein the number of the sustain pulses supplied to the electrodes during a sustain period of a subfield of the plurality of subfields is equal to the number of the sustain pulses supplied to the electrodes during a sustain period of another subfield.

14. A plasma display apparatus comprising:
a plasma display panel comprising a plurality of electrodes;
a scan driver for supplying the same number of sustain pulses to the plurality of electrodes during a sustain period of each of a plurality of subfields; and
a timing controller for controlling a duration of a rising period of at least one sustain pulse supplied to the electrodes during a sustain period of at least one subfield of the plurality of subfields to be different from a duration of a rising period of sustain pulses supplied to the electrodes during sustain periods of the remaining subfields.

15. The plasma display apparatus of claim 14, wherein a duration of the rising period of the plurality of sustain pulses increases as a sustain period in one subfield elapses.

16. The plasma display apparatus of claim 14, wherein a duration of the rising period of the plurality of sustain pulses decreases as a sustain period in one subfield elapses.

17. The plasma display apparatus of claim 14, wherein a duration of the rising period of the plurality of sustain pulses increases and then decreases as a sustain period in one subfield elapses.

18. The plasma display apparatus of claim 14, wherein a sustain voltage supply switch of the scan driver controls a duration of the rising period of the plurality of sustain pulses through the control of turn-on time of the switch.

19. The plasma display apparatus of claim 14, wherein the plurality of sustain pulses supplied to the electrodes during the sustain period of each of the plurality of subfields have a substantially constant voltage level.

20. The plasma display apparatus of claim 14, wherein a duration of time when one sustain pulse of the plurality of sustain pulses supplied to the electrodes is maintained at a constant voltage level during the sustain period of each of the plurality of subfields is equal to a duration of time when another sustain pulse of the plurality of sustain pulses is maintained at a constant voltage level.
